(19) United States
(12) Patent Application Publication
(10) Pub. No.: US 2011/0181977 A1
(43) Pub. Date: Jul. 28, 2011

(54) METHOD OF WRITING SERVO PATTERN TO DISK OF A HARD DISK DRIVE AND HARD DISK DRIVE CONFIGURED TO PERFORM THE METHOD

(75) Inventors: Ha Yong Kim, Seoul (KR); Kyung Ho Kim, Seoul (KR); Kyu Nam Cho, Seoul (KR); Yong-Soo Kim, Seoul (KR)

(73) Assignee: SAMSUNG ELECTRONICS CO., LTD., Suwon-si (KR)

(21) Appl. No.: 12/983,902

(22) Filed: Jan. 4, 2011

(30) Foreign Application Priority Data
Jan. 25, 2010 (KR) 10-2010-0006427

(51) Int. Cl. G11B 5/596; G11B 5/02; G11B 5/09

(52) U.S. Cl. 360/48; 360/55; 360/78.14; G9B/5.026; G9B/5.033; G9B/5.228

(57) ABSTRACT

A method of writing a servo pattern of a hard disk drive includes measuring the speed of a head of the hard disk drive by reading a basic servo pattern written to only select ones of the data tracks of the disk, realizing a feedforward current profile when the difference between the actual speed of the head and a target speed of the head is within a predetermined range, and writing a reference servo pattern using the realized feedforward current profile. A final servo pattern is then written using the reference servo pattern.

### PRIORITY STATEMENT

This application claims the benefit of Korean Patent Application No. 10-2010-0006427, filed on Jan. 25, 2010, in the Korean Intellectual Property Office.

### BACKGROUND

The inventive concept relates to hard disk drives. More particularly, the inventive concept relates to the writing of servo patterns on disks of hard disk drives (HDD).

Hard disk drives (HDDs) are data storage devices for recording data on a disk or reproducing data recorded on the disk by converting digital electronic pulses representative of the data into a permanent magnetic field. HDDs are widely used as memory devices of computer systems because a large amount of data may be recorded and reproduced at high speeds using an HDD.

The HDD typically includes a disk stack assembly having a disk for recording and storing data, a spindle motor for rotating the disk, a head stack assembly (HSA) supported so as to be rotatable about an axis, a printed circuit board assembly (PCBA) for controlling various circuit parts mounted on a printed circuit board (PCB), a base on which the above constituent parts are assembled, and a cover for covering the base.

The HSA includes a head for writing data to the disk or reading data from the disk while moving over a recording surface of the disk, an actuator arm mounted to a pivot and supporting the head, a voice coil motor (VCM) for rotating the actuator arm to thereby move the head supported by the arm, and an outer disk crash stop (ODCS) and an inner disk crash stop (IDCS) for restricting the range of rotation of the actuator arm. The ODCS and IDCS are buffering means for preventing the head from moving to a position where disk servo information is not written.

A read/write operation of reading or writing data begins with an accurate positioning of the head. This is accomplished by reading a servo pattern written on a servo track of a disk.

A conventional method of recording such a servo pattern on a disk in an HDD uses a mechanical push pin and a servo track writer having a high precision encoder. The servo track writer is located outside the HDD. One end of the mechanical push pin is attached to a master actuator arm of the HDD, and the other end thereof extends through a slot in the housing of the HDD to the servo track writer outside the HDD. Using the mechanical push pin, the servo track writer controls the positioning of the head in the radial direction of the disk to cause the head to write the servo pattern to the disk. Thus, at this time, the movement of the mechanical push pin and the final movement of the master actuator arm are controlled by the high precision encoder and a positioner. In addition, a clock head is instructed to write, to a disk, clock information by which the relative position in a direction of rotation of the disk can be determined.

In the conventional process described above, the precision at which the positioning of the head is controlled, during the writing of the servo pattern, is adversely affected by non-repeatable run out (NRRO), disk flutter, and vibrations of a motor. Also, the use of the servo track writer having the positioner/encoder contributes significantly to the cost of producing the HDDs.

Servo writing methods developed to address these problems include an offline servo track write (OLSTW) method and a self-servo writing method. The OLSTW method is technique in which a servo pattern is written on a disk in advance using an offline servo track writer, i.e., before the disk is assembled in the HDD. However, repeatable run out (RRO) due to disk eccentricity is high in this method, and this method may also necessitate an excessive amount of additional track seeking. In the self-servo writing method, a reference servo pattern is written by a servo track writer to one (a reference disk) of several assembled disks and then an HDD itself writes a final servo pattern onto each of the other disks by referring to the reference servo pattern on the reference disk. The quality of the final servo pattern thus corresponds to the degree of precision of the reference servo pattern. Moreover, the self-servo writing method is time consuming.

Furthermore, the self-servo writing method may comprise either a burst method or a spiral method. In the burst method, the reference servo pattern is written onto the reference disk along a circle beginning at a location along a radius of the disk. In the spiral method, the reference servo pattern is written along a spiral path on the reference disk. Servo pattern writing using the spiral method is faster than servo pattern writing using the burst method.

However, each of the conventional self-servo pattern writing methods requires using a servo track writer in a clean room to write the reference servo pattern. This processing time in the clean room is relatively long and thus, HDDs whose disks have servo patterns written by a self-servo writing method incur high production costs. Furthermore, the use of the clean room is expensive and thus, also contributes to increasing the cost of producing the HDDs.

The OLSTW method is widely used for mass production. As was mentioned above, a servo pattern is recorded by a self-contained servo track writer, and then the disk on which the reference servo pattern has been recorded is assembled to the HDD and a servo pattern is recorded by the HDD by referring to the reference servo pattern. Accordingly, the quality of the servo pattern is influenced by characteristics of the HDD itself and characteristics of the servo track writer. Thus, the quality of the servo pattern may be poor.

FIG. 1 schematically illustrates a conventional servo pattern writing method using a servo track writer to write a reference servo pattern. Referring to FIG. 1, reference numeral 11 denotes a disk 111 mounted to the spindle motor (not shown) of the HDD, reference numeral 123 denotes the actuator arm, reference numeral 121 denotes the head supported by the actuator arm, reference numeral 117 denotes an ODCS, reference numeral 118 denotes an IDCS, and reference numeral 125 denotes the voice coil motor (VCM). A spiral reference servo pattern (whose form is denoted in general by reference numeral 100 in the figure) is recorded on the disk 111 by moving the head 121 in a radial direction between radial positions R1 and R2 and simultaneously rotating the disk 111 at a constant velocity. When the actuator arm 123 is moved with respect to the disk 111, the head 121 is confined between the radial positions R1 and R2 on the disk 111 by the ODCS 117 and the IDCS 118. However, when the actuator arm 123 bumps against the crash stops ODCS 117 and IDCS 118, the head 21 may be damaged.

The velocity of the head 121 must be controlled to be constant if a precise spiral is to be traced for forming the reference servo pattern. In this case, the spiral reference servo pattern is written using a back EMF method in which the speed of the head 121 is controlled based on the voltage that occurs in the VCM. However, it is difficult to attain a constant velocity for the head 121 using the back EMF method because noise is mixed with the back EMF voltage.

FIG. 2 illustrates in more detail the shape of the spiral reference servo pattern 100 being recorded on the disk 111. The number of turns of the spiral reference servo pattern 100 is equal to at least the number of sectors (actually about twice the number of sectors) of the disk 111 (each sector of the disk including respective portions of tracks along which servo data and user date are recorded). Although not illustrated precisely in FIG. 2, the spiral reference servo pattern 100 includes about 20 turns between R1 and R2.

Furthermore, a clock signal (not shown) is recorded at the outermost circumferential portion of the disk 111 by a clock head (not shown) of the servo track writer. The clock head of the servo track writer is inserted into the HDD through another slot in the housing of the HDD. The clock signal is for indicating the intervals which are to be provided between the turns of the spiral reference servo pattern 100.

FIG. 3 illustrates details of the spiral reference servo pattern 100 recorded on the disk 111. Referring FIG. 3, the spiral reference servo pattern 100 has a burst 302 and sync bits 304. The process of recording a final servo pattern by referring to the spiral reference servo pattern 100 is referred to as a servo copy process. In the servo copy process, a final servo pattern is recorded along each of concentric tracks by connecting sync bits 304 located at equal distances from the center of the disk, i.e., at the same relative positions in the radial direction of the disk 111.

### SUMMARY

According to an aspect of the inventive concept, there is provided a method of writing a servo pattern, which includes providing a disk having a basic servo pattern written to select ones only of the tracks of the disk, moving a head of the hard disk drive over the disk and reading the basic servo pattern to determine the actual speed of the head, comparing the determined speed of the head and a target speed of the head, once the difference between the actual speed of the head and the target speed is within a predetermined range, realizing a feedforward current profile, and writing the reference servo pattern onto the disk including by supplying current, that moves the head over the disk, having a profile corresponding to the feedforward current profile. The feedforward current profile is one that corresponds to a profile of the current that is at that time being supplied to move the head over the disk.

According to another aspect of the inventive concept, there is provided a hard disk drive including a disk, a head for writing/reading data onto/from the disk, and a controller operatively connected to the head and configured to determine an actual speed at which the head is moved across the disk, realize a feedforward current profile when the difference between the determined actual speed of the head and a target speed of the head is within a predetermined range, and issue commands that cause a reference servo pattern to be written onto the disk based on the feedforward current profile realized.

### BRIEF DESCRIPTION OF THE DRAWINGS

Embodiments of the inventive concept will be more clearly understood from the following detailed description thereof made in conjunction with the accompanying drawings in which:

FIG. 1 is a schematic diagram of components of an HDD illustrating a conventional spiral reference servo pattern writing method;

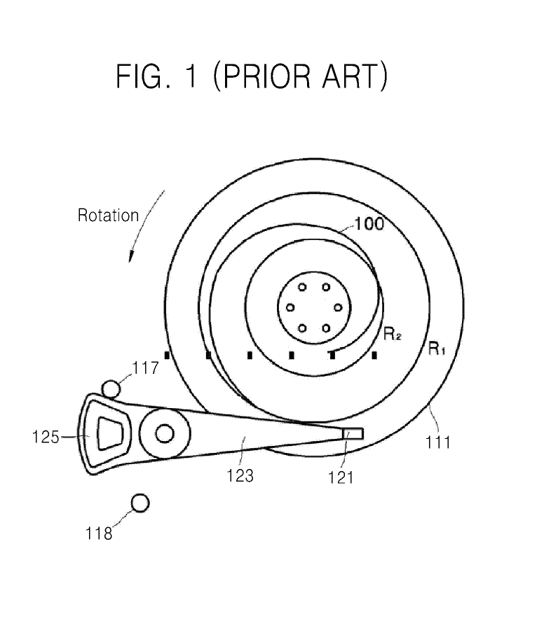

FIG. 2 is a schematic plan view of a disk illustrating a conventional spiral reference servo pattern recorded on a disk;

FIG. 3 is a graph of features of a conventional spiral reference servo pattern recorded on a disk;

FIG. 4 is an exploded perspective view of an HDD employing a method of writing a servo pattern onto a disk according to the present inventive concept;

FIG. 5 is a plan view of a disk of the HDD of FIG. 4;

FIG. 6 is a diagram of the data format of each track of the disk in the HDD of FIG. 4;

FIG. 7 is a diagram the data format of a servo sector shown in the diagram of FIG. 6;

FIG. 8 is a block diagram of a driving circuit of an HDD employing a method of writing a servo pattern according to the present inventive concept;

FIG. 9 is a flowchart of the method of writing a servo pattern onto the disk of an HDD according to present inventive concept;

FIG. 10 is a schematic plan view of a disk of an HDD provided with a basic servo pattern form which a spiral reference servo pattern can be produced, according to the inventive concept;

FIG. 11A is a graph illustrating a feedforward profile of current supplied to a head of an HDD during a dummy writing process in which the head traces a spiral pattern over a disk, in the servo writing method according to the inventive concept;

FIG. 11B is a graph illustrating the profile of a target speed of the head for creating a spiral trace; and

FIG. 12 is a diagram showing gray code superimposed with a spiral trace.

### DETAILED DESCRIPTION OF THE PREFERRED EMBODIMENTS

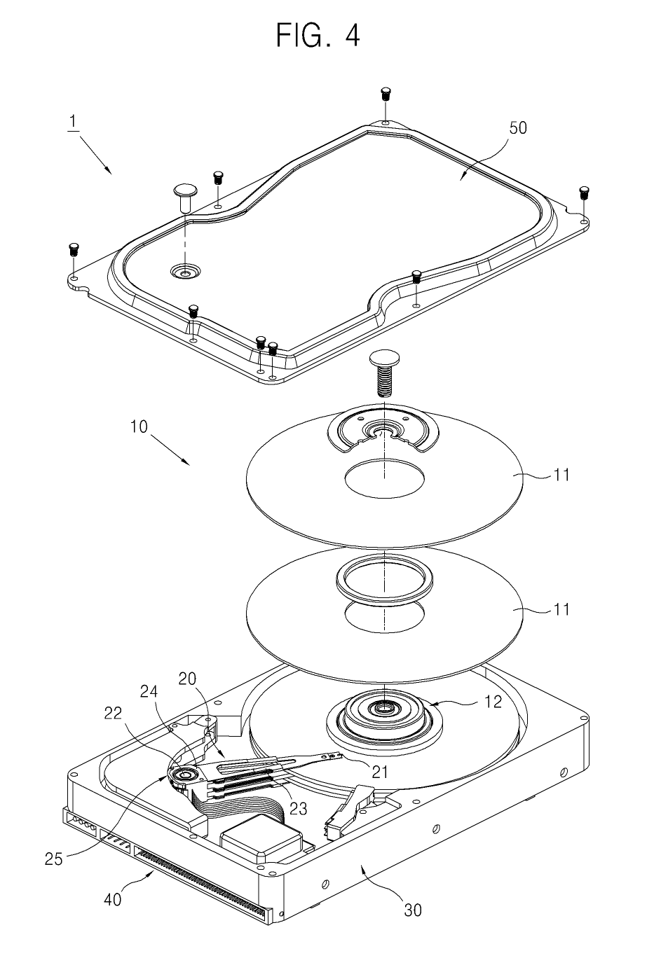

Embodiments of the inventive concept will be described in detail hereinafter with reference to FIGS. 4-12. Like reference numerals in the drawings denote like elements. Also, the inventive concept will be described below with respect to a single head and disk for the sake of simplicity, but the inventive concept also applies to HDDs having multiple heads and a disk stack.

Referring first to FIG. 4, an HDD 1 according to the inventive concept may include a disk pack 10 having a disk 11 for recording and storing data and a spindle motor (SPM) 12 for supporting and rotating the disk 11, a head stack assembly (HSA) 20 for reading out data from the disk 11, a base 30 on which constituent parts are assembled, a printed circuit board assembly (PCBA) 40 coupled to a lower portion of the base 30 and controlling various circuit parts mounted on a printed circuit board (PCB) of the PCBA 40, and a cover 50 covering the base 30.

The HSA 20 is a carriage that may include a head 21 for writing data to the disk 11 or reading recorded data, an actuator arm 23 supported to rotate about an axis of a pivot shaft 22 to move the head 21 over the disk 11, a pivot shaft holder 24 rotatably supported by the pivot shaft 22 and to which the actuator arm 23 is coupled, and a bobbin (not shown) provided on the opposite side of the pivot shaft holder 24 with respect to the actuator arm 23 and around which a voice coil (not shown) is wound.

The head 21 reads or record information from or onto the disk 11, while the disk 11 is rotating, by detecting a magnetic field emanating from a surface of the disk 11 or by magnetizing a surface of the disk 11. The head 21 may include a read head for reading data from a track or a write head for writing data to a track. The bobbin and hence, the voice coil, are located between magnets mounted to the base 30. These magnets and the voice coil constitute a voice coil motor (VCM) 25 for rotating the actuator arm 23 about the pivot shaft 22 to move the head 21 to a desired position over the disk 11.

A force is applied to the bobbin by applying current to the voice coil interposed between the magnets because, as is well known, an electromotive force is generated on a conductor (in this case the voice coil) situated in a magnetic field when current flows through the conductor. The force acts on the conductor in a direction according to Fleming's left hand rule. Thus, the VCM 25 rotates the bobbin about the axis of the pivot shaft 22 in a direction depending on the direction in which current is supplied to the voice coil. As a result, the actuator arm 23 extending from the pivot shaft holder 24 bobbin rotates in a direction opposite to the direction of rotation of the bobbin, to move the head 21 supported at an end of the actuator arm 23 to a position over the disk 11. The head 21 thus accesses a track of the disk 11 that is rotating. If a read operation, for example, is being carried out, the head 21 detects information from the track and outputs corresponding information in the form of signals, i.e., the information is signal processed.

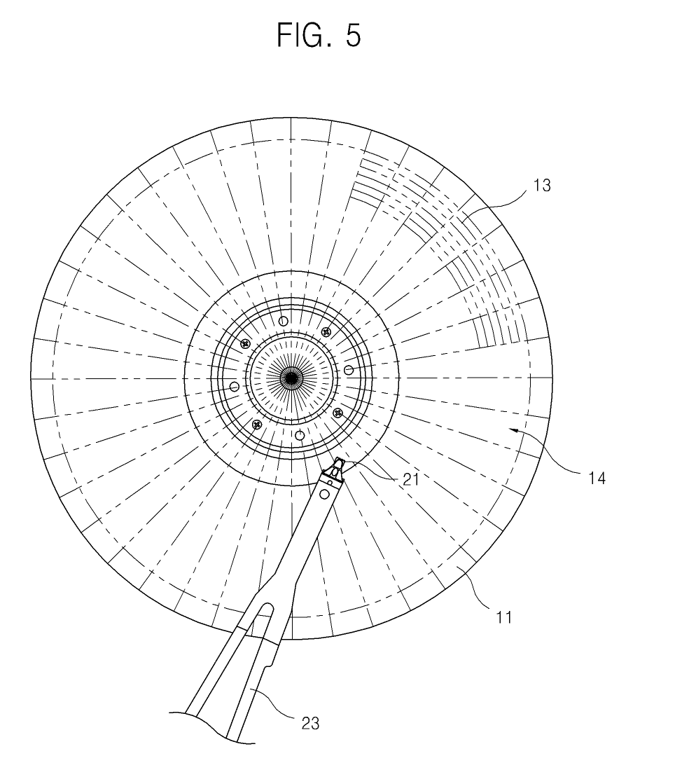

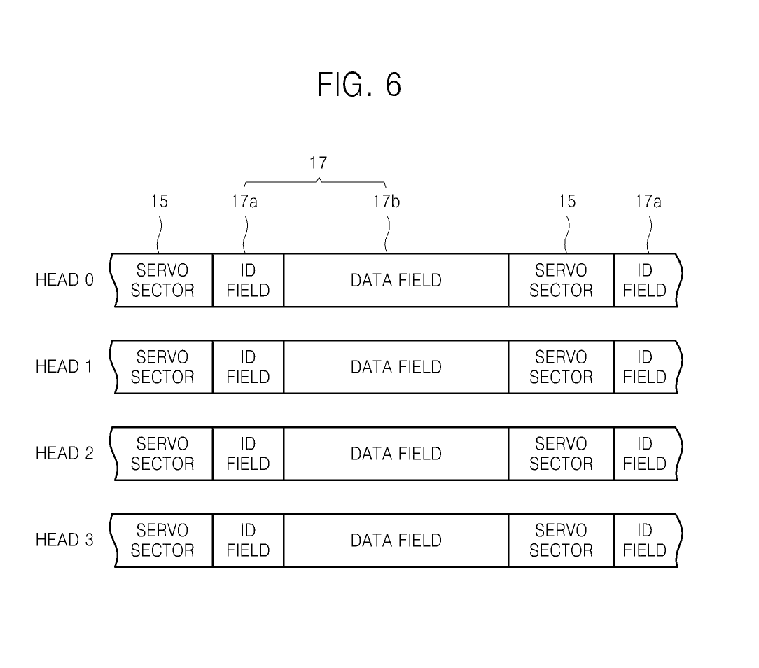

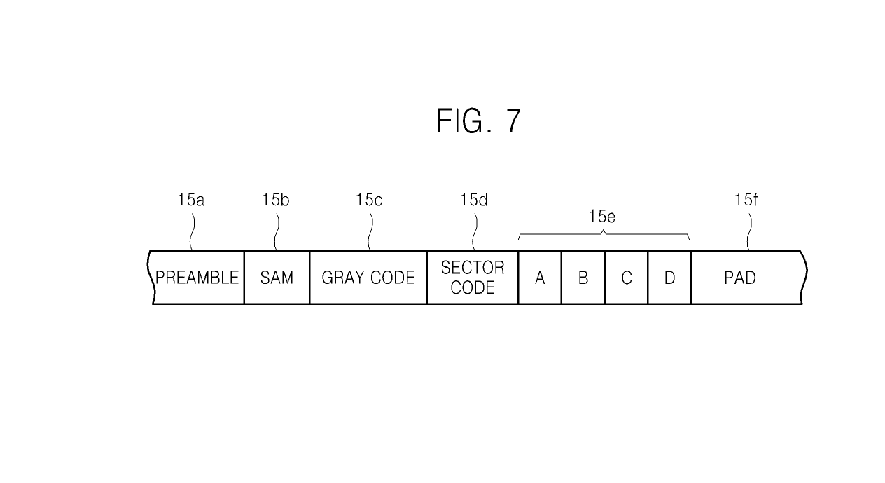

Referring to FIG. 5, the disk 11 has a plurality of tracks 13 along which servo information and data information are stored/recorded. Each track 13 is divided into a plurality of sectors 14 obtained by dividing the track 13 at equal angular intervals with respect to the center of rotation of the disk 11. As illustrated in FIG. 6, the sectors 14 of each track 13 consist of servo sectors 15 and data sectors 17 alternately disposed along the track. The servo sectors 15 are for storing information that provides a servo control which allows the head to find and/or follow the track (such a servo control may be referred to as “track seeking and track following”). The data sectors 17 are the locations where user data is stored/recorded. As illustrated in FIG. 7, each servo sector 15 includes a preamble 15a, a servo address mark (SAM) 15b, a gray code 15c, a sector code 15d, bursts A, B, C, and D 15e, and a PAD 15f.

The preamble 15a provides clock sync during the reading of servo information and at the same time provides a gap to indicate that the head 21 is over a servo sector, which operation is referred to as servo sync. The SAM 15b provides sync to read the gray code 15c following the indication of the start of a servo sync. That is, the SAM 15b is provided as a reference point for generating various timing pulses related to servo control. The gray code 15c provides information about each of the tracks 13, that is, track information. The sector code 15d provides the number of the sector. The bursts A, B, C, and D 15e provide a position error signal (PES) required for the track seek and track following. Finally, the PAD 15f provides a margin for the transition from the servo sector 15 to the data sector 17.

Each data sector 17 includes an ID field 17a and a data field 17b. Header information for identifying the data sector is recorded in the ID field 17a. Digital data that a user desires to record, for example, is recorded in the data field 17b.

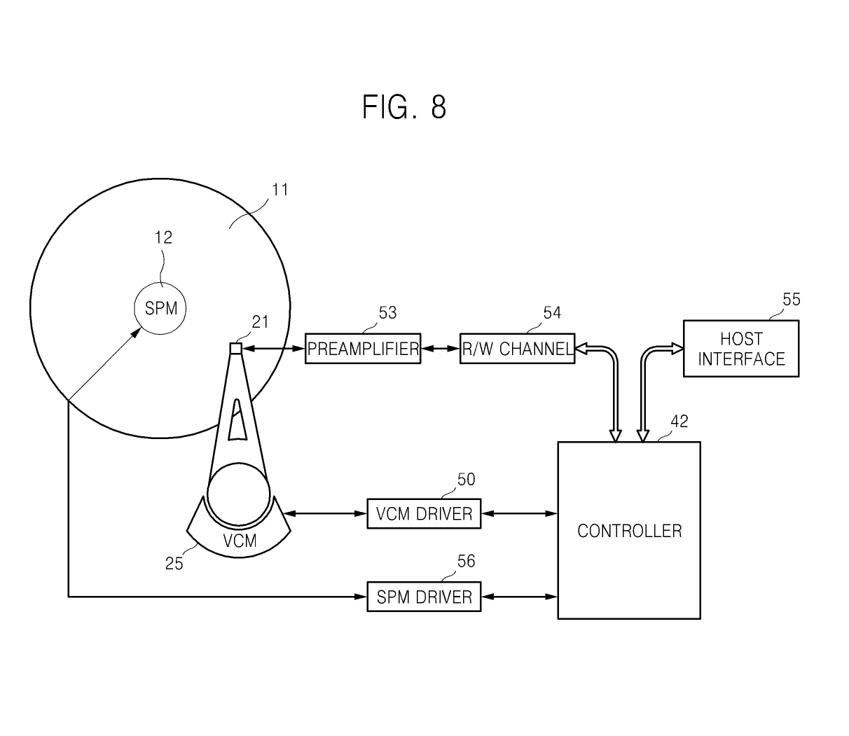

Referring to FIG. 8, the driving circuitry of the HDD 1 may include a preamplifier 53, a read/write (R/W) channel 54, a host interface 55, a VCM driver 50, a spindle motor (SPM) driver 56, and a controller 42 for controlling these components. The controller 42 may be a microprocessor or a microcontroller, or may be embodied by software or firmware.

The preamplifier 53 amplifies a data signal produced by the head 21 upon reading data from the disk 11 or a write current converted by the R/W channel 54. Thus, an amplified data signal or amplified write current is read from or recorded on the disk 11 using the head 21.

During a read operation, i.e., in a data detection mode, the R/W channel 54 converts the signal amplified by the preamplifier 53 into a digital signal and transmits the digital signal to a host apparatus (not shown) through the host interface 55. Furthermore, during a write operation, i.e., in a data write mode, the R/W channel 54 receives user data input through the host interface 55, converts the user data into a binary data stream that is easy to record, and inputs the binary data stream to the preamplifier 53.

The host interface 55 transmits data that is converted into a digital signal to the host apparatus, or receives the user data from the host apparatus and inputs the received user data to the R/W channel 54 through the controller 42.

The VCM driver 50 receives a control signal of the controller 42, and based on the control signal adjusts the current supplied to the voice coil of the VCM 25. The SPM driver 56 receives a control signal of the controller 42, and based on that control signal adjusts the amount of current applied to the SPM 12.

In the data write mode, the controller 42 receives data input by a user through the host apparatus via the host interface 55 and outputs received user data to the R/W channel 54. On the other hand, in the data detection mode, the controller 42 receives a read signal converted by the R/W channel 54 into a digital signal and outputs the digital signal to the host interface 55. Also, as is clear from the description above, the controller 42 controls the outputs of the VCM driver 50 and the SPM driver 56.

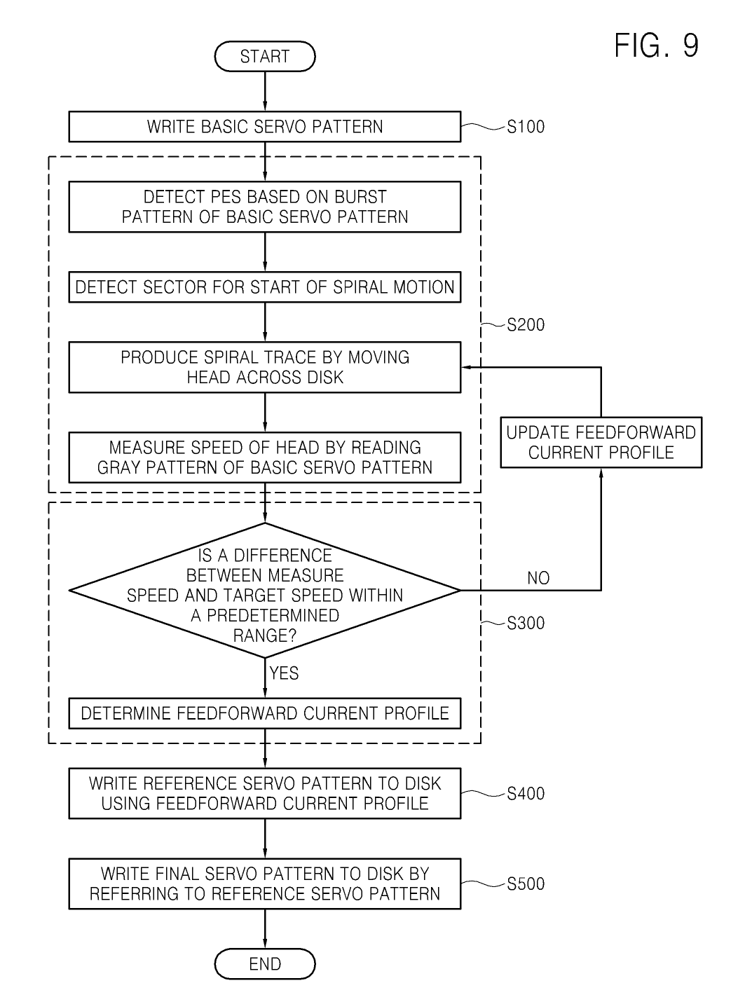

In addition, the controller 42 realizes a feedforward current profile to be used for forming a reference servo pattern, and controls the head 21 to record the reference servo pattern using the realized feedforward current profile. This process will be described in more detail in connection with the description that follows of a method of writing a servo pattern onto a disk 11 of an HDD according to the inventive concept. For this description, reference will be made to FIGS. 9-12.

Referring first to FIG. 9, the method includes writing a basic servo pattern onto select ones of the tracks in of the disk 11 where data is recorded (S100), measuring the speed of the head 21 by reading the basic servo pattern (S200), originating a feedforward current profile, to be used for forming a reference servo pattern, when the difference between the measured speed of the head 21 and a target speed of the head 21 is within a predetermined range (S300), writing the reference servo pattern using the feedforward current profile (S400), and writing a final servo pattern using the reference servo pattern (S500). These processes will be described in more detail below.

As mentioned above, first a basic servo pattern is written onto selected ones of the tracks of the disk 11 where data is recorded (S100). The basic servo pattern may be recorded in only several minutes by an offline servo track writer or a servo track writer. Alternatively, the basic servo pattern may be readily produced by a magnetic printing method. In any case, the basic servo pattern is written in an on-drive state in which the disk 11 is assembled in the HDD.

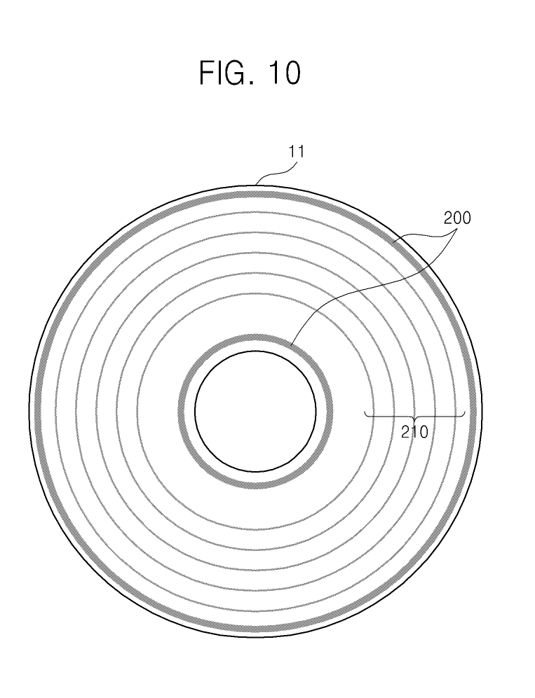

The basic servo pattern, as shown in FIG. 10, includes a burst pattern 200 recorded along an OD (outer diameter) portion and along an ID (inner diameter portion) of the disk which extend alongside the outer periphery and the inner periphery of the disk 11, respectively, and a gray pattern 210 in which gray code is recorded for select tracks between the OD and the ID portions. In an example of the present embodiment, the gray pattern 210 is recorded in about five regions between the OD and the ID, and there are about 100 tracks per each such region. The gray code of the gray pattern 210 is used to measure the speed of the head 21 during a dummy writing operation that will be described later.

The burst pattern 200 is used to limit the start position and end position of the head 21. More specifically, the burst pattern 200 along the OD portion of the disk 11 provides a starting point for the head 21 when it writes a spiral reference pattern. Furthermore, the burst pattern 200 along both the OD and ID portions of the disk 11 are used as stops for the head 21 during the process in which the head is writing a spiral reference pattern as well as to prevent the head 21 from otherwise bumping against a hub (not shown) of the SPM 12.

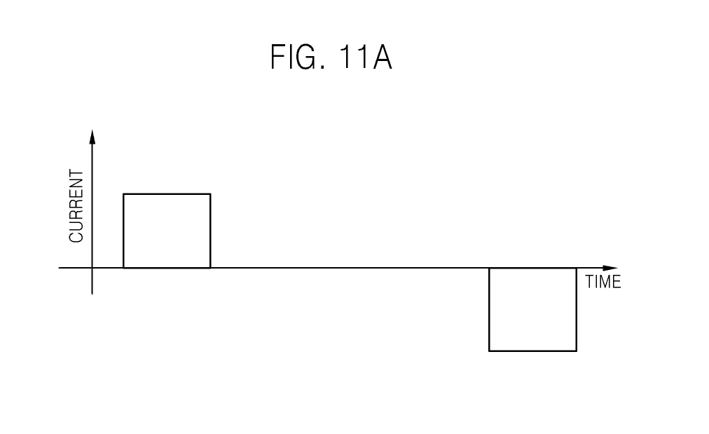

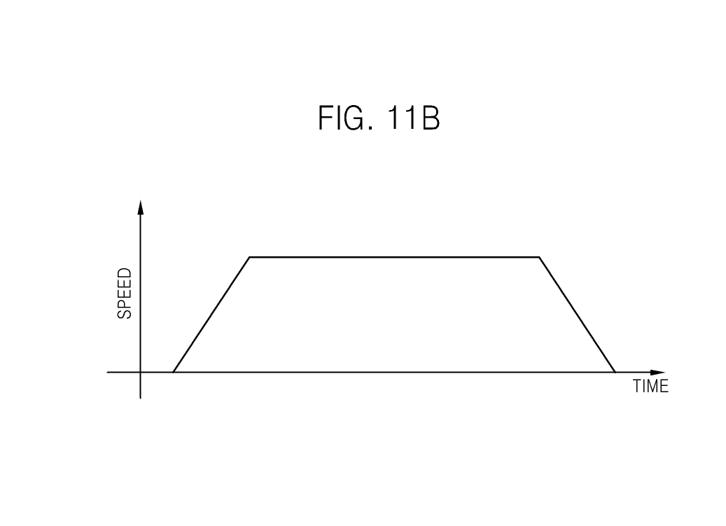

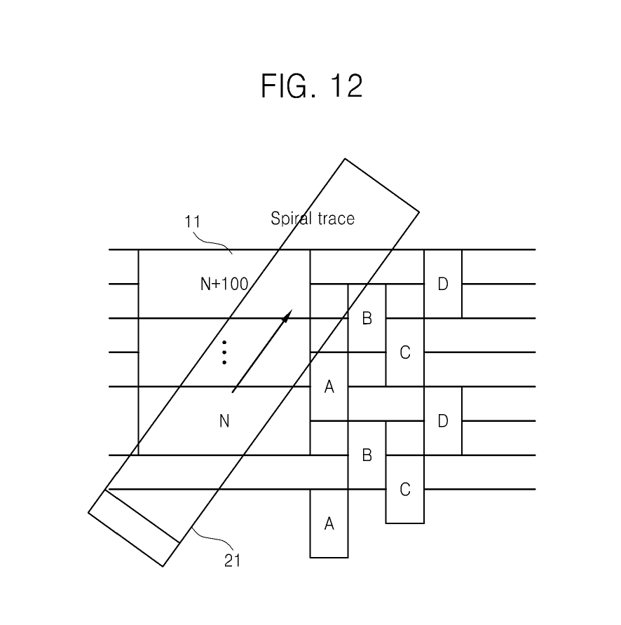

Next, the speed of the head 21 of the HDD is measured (S200) using the disk 11 on which the basic servo pattern has been written, i.e., while the disk is assembled in the HDD 1. First, a position error signal (PES) is detected using the burst pattern 200 whereby the head 21 follows the burst pattern along the OD portion of the disk 11. Furthermore, the head 21 detects the sector of the disk 11 at which a dummy write operation is to be initiated. Once the head 21 is located over the sector, a feedforward current having a profile as illustrated in FIG. 11A is applied to the VCM by the VCM driver 50. As a result, the dummy writing operation is initiated and the head 21 moves from a start position to an end position, namely, between the OD portion and the ID portion of the disk 11, and thereby tracing a spiral over the disk 11. At this time, i.e., during the dummy writing operation, nothing is recorded on the disk and, as illustrated in FIG. 12, the head 21 reads the gray pattern 210. The intervals between the times that the head 21 picks up the gray codes of the gray pattern 210 are clocked, and such time intervals are used to determine the speed of the head 21.

FIG. 11B shows the profile of the target speed of the head 21. Even when current supplied to the VCM has the feedforward profile illustrated in FIG. 11A, the profile of the actual speed of the head 21 may differ from the profile shown in FIG. 11B due to interference such as friction between the actuator and the pivot to which the actuator is mounted or due to resistance provided by a flexible PCB (not shown) connected to the actuator. Thus, an actual feedforward current profile that induces the precise target movement speed profile shown in FIG. 11B is needed.

This is because the head 21 must move at a constant velocity to produce constant intervals between the sync bits and the burst of the spiral reference servo pattern. That is, the head 21 can only record a precise spiral reference servo pattern if the head 21 is moving across the disk 11 at a constant velocity in the radial direction. In particular, the speed of the head 21 must be constant, as shown in the constant velocity section of the profile illustrated in FIG. 11B, between the OD portion of the disk 11 (which includes the start point in the writing of the spiral reference servo pattern) and the ID portion (which includes the end point in the writing of the spiral reference servo pattern).

Accordingly, an actual feedforward current profile is determined (S300). The actual feedforward current profile is representative of current which when supplied to the VCM facilitates the writing of a precise spiral reference servo pattern onto the disk 11.

To this end, an error corresponding to the difference between the target speed of the head 21 and the measured speed of the head 21 is determined. If the error is outside the predetermined range, the feedforward current profile is updated based on the error, namely, the difference between the measured speed of the head 21 and the target speed of the head 21. Then the process of measuring the speed of the head 21 is performed again in another dummy write operation performed using the updated feedforward current profile, i.e., by supplying to the VCM current represented by the updated feedforward current profile. Next, the measured speed of the head is once again compared to the target speed. Once, the error between the measured speed and the target speed is within a predetermined range, the feedforward current profile is realized as the actual feedforward current profile.

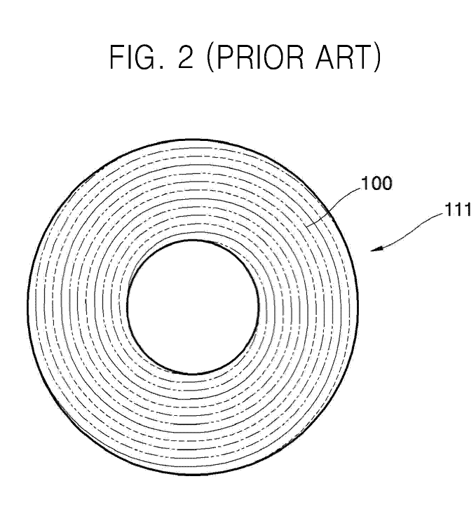

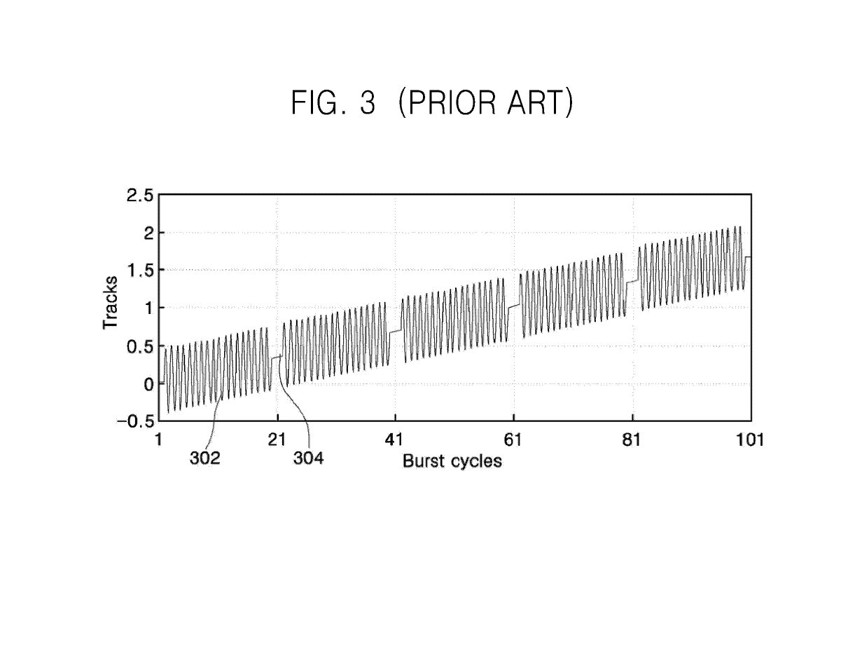

Then, a reference servo pattern is written using the feedforward current profile (S400). In particular, the reference servo pattern is written onto the disk 11 by the head 21 of the HDD 1, i.e., in a state in which the disk 11 is assembled in the HDD 1, and under the controller 42 of the HDD 1. That is, the controller 42 accesses the feedforward current profile and controls the VCM driver 50 to supply current to the VCM based on the feedforward current profile, and at the same time commands the head 21 through the R/W channel 54 to write burst and sync bits. As a result, a reference servo pattern having a spiral shape as illustrated in FIG. 2 and made up of bursts and sync bits as illustrated in FIG. 3 is written to the disk 11 by the head 21.

Next, a final servo pattern is written onto the disk 11 based on the reference servo pattern (S500). More specifically, the final servo pattern is written by the head 21 of the HDD 1, i.e., again, in a state in which the disk 11 is assembled in the HDD 1. The writing of the final servo pattern is also controlled by the controller 42 of the HDD 1. To this end, the controller 42 controls the head 21 to connect each set of sync bits of the reference servo pattern that are located at the same distance from the center of the center of the disk 11, i.e., in the radial direction of the disk 11. Accordingly, the head 21 writes a respective servo pattern along each of a plurality of concentric tracks.

After the final servo pattern has been written, the reference servo pattern is removed, i.e., is erased with reference to the final servo pattern. In the present embodiment, however, the burst pattern 200 remains on the disk 11 after the reference servo pattern has been removed.

As described above, in a method of writing a servo pattern according to the inventive concept, the writing of the reference servo pattern onto the disk 11 is not performed in a clean room. That is, any production time in the clean room may be minimal so that the efficiency and productivity of the method is maximized while production costs are held in check. Furthermore, the reference servo pattern is written onto the disk 11 in an on-drive state by the HDD 1. More specifically, the reference servo pattern is written using a very basic servo pattern that enables self servo writing in an on-drive state. Thus, the reference servo pattern is influenced substantially only by characteristics of the HDD 1. Accordingly, an HDD 1 having a disk 11 whose servo pattern is of an excellent quality can be realized.

Finally, the inventive concept has been described above in detail with respect to preferred embodiments thereof. The inventive concept may, however, be embodied in many different forms and should not be construed as being limited to the embodiments described above. Rather, these embodiments were described so that this disclosure is thorough and complete, and fully conveys the inventive concept to those skilled in the art. Thus, the true spirit and scope of the inventive concept is not limited by the embodiments described above but by the following claims.

What is claimed is:

1. A method of writing a servo pattern of a hard disk drive, the method comprising:
providing a disk having a plurality of tracks arrayed in the radial direction of the disk, and a basic servo pattern recorded on select ones only of the tracks;
moving a head of the hard disk drive over the disk provided with the basic servo pattern and at that time, reading the basic servo pattern to determine the actual speed of the head;
comparing the determined speed of the head and a target speed of the head;
once the difference between the actual speed of the head and the target speed is within a predetermined range, realizing a feedforward current profile which corresponds to a profile of the current that is at that time being supplied to move the head over the disk; and
writing the reference servo pattern onto the disk including by supplying current, that moves the head over the disk, having a profile corresponding to the feedforward current profile.

2. The method of claim 1, wherein the providing of the disk comprises writing the basic servo pattern onto the disk as a gray pattern comprising a gray code in each of the selected tracks, the selected tracks being located between an outer diameter portion and an inner diameter portion of the disk, and
the reading of the basic servo pattern to determine the actual speed of the head comprises reading the gray code.

3. The method of claim 2, wherein the writing of the basic servo pattern further comprises writing a burst pattern written along the outer diameter portion of the disk, and
the writing of the reference servo pattern onto the disk comprises determining a position along the disk at which the writing of the reference servo pattern is to begin using a position error signal and sector information derived from the burst pattern.

4. The method of claim 2, wherein the writing of basic servo pattern further comprises writing a burst pattern along the inner diameter portion of the disk, and
the writing of the reference servo pattern onto the disk comprises determining a position along the disk at which the writing of the reference servo pattern is to be terminated using the burst pattern written along the inner diameter portion of the disk.

5. The method of claim 1, further comprising performing an iteration in which the feedforward current profile is updated, based on the difference between the determined actual speed of the head and the target speed of the head, when the difference is out of the predetermined range, and the speed of the head is determined again after the feedforward current profile is updated.

6. The method of claim 1, wherein the providing of the disk comprises writing the basic servo pattern with an offline servo track writer or using a magnetic printing method.

7. The method of claim 1, wherein the writing of the reference servo pattern is performed in an on-drive state in which the disk is assembled in the hard disk drive.

8. The method of claim 1, wherein the writing of the reference servo pattern comprises writing the reference servo pattern in the form of a spiral between an inner peripheral portion of the disk and an outer peripheral portion of the disk.

9. The method of claim 1, further comprising writing a final servo pattern by referring to the reference servo pattern.

10. A hard disk drive comprising:
a disk;
a head for writing/reading data onto/from the disk, the head being supported so as to be movable across a surface of the disk; and
a controller operatively connected to the head and configured to determine an actual speed at which the head is moving across the disk, realize a feedforward current profile when the difference between the determined actual speed of the head and a target speed of the head is within a predetermined range, and issue commands that cause a reference servo pattern to be written onto the disk based on the feedforward current profile realized.

11. The hard disk drive of claim 10, wherein the disk has a plurality of data tracks arrayed in the radial direction of the disk, and a basic servo pattern recorded on only select ones of the tracks, and the controller is configured to determine the actual speed of the head based on a reading of the basic servo pattern by the head.

12. The hard disk drive of claim 11, wherein the basic servo pattern comprises a gray pattern comprising a gray code in each of the select ones of the tracks, and the controller is configured to determine the actual speed of the head based on a reading of the gray code by the head.

13. The hard disk drive of claim 12, wherein the basic servo pattern further comprises a burst pattern written along an outer diameter portion of the disk, and
the controller is configured to determine a position along the disk at which the writing of the reference servo pattern is to begin using a position error signal and sector information derived from the burst pattern.

14. The hard disk drive of claim 12, wherein the basic servo pattern further comprises a burst pattern written along an inner diameter portion of the disk, and
the controller is configured to determine, using the burst pattern written along the inner diameter portion of the disk, a position along the disk at which the writing of the reference servo pattern is to be terminated.

15. The hard disk drive of claim 10, wherein the controller is configured to update the feedforward current profile, based on the difference between the determined actual speed of the head and the target speed of the head, when the difference between the determined actual speed of the head and the target speed of the head is outside a predetermined range.

16. The hard disk drive of claim 10, wherein the disk has a spiral reference servo pattern.

17. The hard disk drive of claim 16, wherein the controller has a program to erase the reference servo pattern.

18. The hard disk drive of claim 10, further comprising a motor supporting the disk and drivable to rotate the disk about an axis, an actuator to which the head is coupled and supported in the drive so as to be rotatable about an axis of a pivot parallel to the axis of rotation of the disk, and a voice coil motor operatively associated with the actuator so as to rotate the actuator about the axis of the pivot, the voice coil motor including a voice coil integrated with the actuator, and wherein the controller is operatively connected to the voice coil motor so as to control current supplied to the voice coil motor, and the feedforward current profile corresponds to a profile of the current supplied to the voice coil under the command of the controller when the reference servo pattern is to be written onto the disk.
